(19) United States
(12) Patent Application Publication
(10) Pub. No.: US 2026/0346310 A1
(43) Pub. Date: Nov. 5, 2026

(54) SYSTEM AND METHOD FOR EXTRACTING MAGNETS FROM A VARIETY OF HARD DRIVES

(71) Applicant: CYCLIC MATERIALS, Toronto (CA)

(72) Inventors: Jonathan CIANCI, Perth Road (CA); Patrick William NEE, Jr., New York, NY (US); Alexander FORSTNER, Peterborough (CA)

(21) Appl. No.: 19/483,711

(22) PCT Filed: Apr. 29, 2025
(86) PCT No.: PCT/IB2025/054471

§ 371 Date: Nov. 12, 2025

Related U.S. Application Data
(60) Provisional application No. 63/640,702, filed on Apr. 30, 2024.

(51) Int. Cl. B09B 3/35; B09B 101/15; B21D 28/04; B21D 43/08; B21D 45/02

(52) U.S. Cl. CPC B09B 3/35; B21D 28/04; B21D 43/08; B21D 45/02; B09B 2101/15

(57) ABSTRACT

A hard drive recycling system and method receive a hard drive comprising a rare earth magnet in one or more peripheral corners or edges of the hard drive, moves the received hard drive along a guide track into a cutting position in which a plane of the cutting surface is transverse to a longitudinal axis of the guide track, in the cutting position, cuts the one or more peripheral corners or edges of the hard drive to form a rare earth magnet-containing portion and a hard drive body portion, removes by a first output the rare earth-magnet-containing portion, and removes by a different second output the hard drive body portion.

### CROSS REFERENCE

This application claims priority to U.S. Provisional Application No. 63/640,702, filed Apr. 30, 2024, entitled “MACHINERY FOR EXTRACTING MAGNETS FROM A VARIETY OF HARD DRIVES,” which is incorporated herein by reference in its entirety.

### FIELD

The disclosure relates generally to recycle of rare-earth-containing materials and particularly to recycle of rare earth-containing magnetic and non-magnetic materials.

### BACKGROUND

Hard disk drives (HDD) and hybrid drives are used as the main storage device in computer devices, which may be either stand-alone systems or part of a network such as data centers. Three-and-a-half inch drives, for example, are commonly included in desktop computers, workstations, and server computers, as well as for mass storage in data centers. Smaller two and a half inch drives are commonly included in laptop computers. Various other sizes of hard disk drives have been provided for various other computer devices.

The current use of hard disk drives (HDD's) and hybrid drives as data storage devices can be an important aspect in their decommissioning, destruction, or recycling in that the destruction or wiping of the stored data must also be secured. Data erasure (also called data clearing or data wiping) is normally a software-based method of overwriting or otherwise rendering unrecoverable any electronic data residing on a hard disk drive or other digital media. Permanent data erasure goes beyond basic file deletion commands, which only remove direct pointers to the data disk sectors and make the data recovery possible with available software tools. Decommissioning of HDDs and hybrid drives often requires physical destruction of electronic storage media to render it unusable. While data erasure is designed to remove all information and leave the disk operable, in many instances the absolute destruction of these data storage systems is desired, preferred, or required due to privacy, security or regulatory requirements (including, but not limited to, the Gramm-Leach-Bliley Act (“GLBA”) 501 and the Health Insurance Portability and Accountability Act (“HIPAA”).

Hard disk drives and hybrid drives include magnets that contain rare earth elements. Rare earth elements are widely considered to be a critical element by Western economies. Most of the global supply of rare earth elements is controlled by China. Due to the potential for significant and catastrophic disruptions in the global supply of rare earth elements, there is an increasing need for rare earth magnet recycling as part of HDD and hybrid drive decommissioning.

### SUMMARY

These and other needs are addressed by the various embodiments and configurations of the present disclosure.

In some aspects of the present disclosure, a magnet-containing hard drive recycling system can include:
(a) an input to receive a hard drive (the hard drive includes a rare earth magnet in one or more of its peripheral corners and/or edges);
(b) a guide track in communication with the input to transport the received hard drive into a cutting position;
(c) a plane of the cutting surface is positioned transverse to a longitudinal axis of the guide track to cut the one or more peripheral corners and/or edges from the hard drive to form a rare earth magnet-containing portion and a hard drive body portion;
(d) a first output to receive the rare earth-magnet-containing portion; and
(e) a second output to receive the hard drive body portion.

In some aspects of the present disclosure, a method for cutting a magnet-containing hard drive can include the steps of:
(a) receiving a hard drive comprising a rare earth magnet in one or more peripheral corners and/or edges of the hard drive;
(b) moving the received hard drive along a guide track into a cutting position in which a plane of the cutting surface is transverse to a longitudinal axis of the guide track;
(c) in the cutting position, cutting the one or more peripheral corners and/or edges of the hard drive to form a rare earth magnet-containing portion and a hard drive body portion;
(d) removing by a first output the rare earth-magnet-containing portion; and
(e) removing by a different second output the hard drive body portion.

In some aspects of the present disclosure, a system for cutting a magnet-containing hard drive can include:
(a) a guide track to receive a hard drive comprising a rare earth magnet in one or more peripheral corners and/or edges of the hard drive;
(b) a cutting surface configured to cut the one or more peripheral corners and/or edges from the hard drive from the hard drive when the hard drive is in a cutting position to form a rare earth magnet-containing portion and a hard drive body portion;
(c) a hard drive orientation sensor to sense whether or not the hard drive is in a correct orientation relative to the plane of the cutting surface to form the rare earth magnet-containing portion;
(d) a displacement device to displace the hard drive along the guide track into the cutting position;
(e) a first output for the rare earth-magnet-containing portion;
(f) a different second output for the hard drive body portion;
(g) a processor coupled with the hard drive orientation sensor and displacement device; and
(h) a computer-readable medium coupled with and readable by the processor and storing therein a set of instructions which, when executed by the processor, causes the processor to:
   (h1) enable the displacement device to displace the hard drive into the cutting position when the hard drive orientation sensor senses that the hard drive is in a first orientation; and
   (h2) disable the displacement device from displacing the hard drive into the cutting position when the hard drive orientation sensor senses that the hard drive is not in the first orientation.

The present disclosure can provide a number of advantages depending on the particular configuration. The magnet-containing hard drive recycling system can use a higher capacity punch press rather than other lower capacity shearing devices, such as an alligator shear. By using a magnetic field sensor to sense a magnetic field in only part of the magnet-containing hard drive, the processing time required to generate a correct or incorrect magnet-containing hard drive orientation signal is less resource intensive and much faster, thereby providing a higher magnet-containing hard drive throughput. The magnet-containing hard drive recycling system can separate the cut corner (which comprises no storage medium containing sensitive information) for recycle of the contained rare earth magnets from the magnet-containing hard drive body for disposition in accordance with applicable information privacy laws and regulations, such as IT Asset Disposition (ITAD), Gramm-Leach-Bliley Act (“GLBA”) 501, and the Health Insurance Portability and Accountability Act (“HIPAA”). The recycling system can be deployed at an e-waste facility, such as one offering ITAD services, to remove rare earth magnets from the voice coil or actuator of the magnet-containing hard drive for recycle while still enabling the facility to properly dispose of the other parts of the magnet-containing hard drive, including the sensitive data-containing computer memory in the platters. The system can have the further advantage of relatively brittle rare earth magnets not being caught in and jamming shredders. By avoiding manual or automated removal of the top cover from the chassis and removal of the individual magnet-containing hard drive components the recycle cost for the rare earth magnets can be significantly reduced.

These and other advantages will be apparent from this disclosure.

The phrases “at least one”, “one or more”, “or”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any computer-readable storage and/or transmission medium that participates in providing instructions to a processor for execution. Such a computer-readable medium can be tangible, non-transitory, and non-transient and take many forms, including but not limited to, non-volatile media, volatile media, and transmission media and includes without limitation random access memory (“RAM”), read only memory (“ROM”), and the like. Non-volatile media includes, for example, NVRAM, or magnetic or optical disks. Volatile media includes dynamic memory, such as main memory. Common forms of computer-readable media include, for example, a floppy disk (including without limitation a Bernoulli cartridge, ZIP drive, and JAZ drive), a flexible disk, hard disk, magnetic tape or cassettes, or any other magnetic medium, magneto-optical medium, a digital video disk (such as CD-ROM), any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored. Computer-readable storage medium commonly excludes transient storage media, particularly electrical, magnetic, electromagnetic, optical, magneto-optical signals.

A “computer readable storage medium” may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer-readable signal medium may be any computer readable medium that is not a computer readable storage medium and that can communicate, propagate, or transport a program for use by or in connection with an instruction execution system, apparatus, or device. A computer readable signal medium may convey a propagated data signal with computer readable program code embodied therein, for example, in baseband or as part of a carrier wave. Such a propagated signal may take any of a variety of forms, including, but not limited to, electro-magnetic, optical, or any suitable combination thereof. Program code embodied on a computer readable signal medium may be transmitted using any appropriate medium, including but not limited to wireless, wireline, optical fiber cable, RF, etc., or any suitable combination of the foregoing.

The terms “determine”, “calculate” and “compute,” and variations thereof, as used herein, are used interchangeably, and include any type of methodology, process, mathematical operation, or technique.

As used herein, hard drive or (“HD”) includes any type of rare earth or non-rare earth magnet-containing drive for a computer readable medium, including without limitation hard disk drives (HDDs), hybrid hard drives (HHDs) and solid state hard drives (SSHDs).

A “hard disk drive (HDD)”, “hard disk”, “hard drive”, or “fixed disk” is an electromechanical data storage device that stores and retrieves digital data using magnetic storage with one or more rigid rapidly rotating platters coated with magnetic material. The platters are paired with magnetic heads, usually arranged on a moving actuator arm, which read and write data to the platter surfaces. Data is accessed in a random-access manner, meaning that individual blocks of data can be stored and retrieved in any order. HDDs are a type of non-volatile storage, retaining stored data when powered off. A typical HDD has two electric motors: a spindle motor that spins the disks and an actuator (motor) that positions the read/write head assembly across the spinning disks. The actuator can include a permanent magnet and moving coil motor that swings the heads to the desired position. A metal plate supports a squat rare earth magnet (typically a neodymium-iron-boron(NdFeB) high-flux magnet. HDDs can have a variety of form factors depending on the application.

A “hybrid drive”, or “hybrid hard drive (HHD)” is a logical or physical storage device that combines a faster storage medium such as solid-state drive (SSD) with a higher-capacity hard disk drive (HDD). There are two main configurations for implementing hybrid drives: dual-drive hybrid systems and solid-state hybrid drives (SSHD's). In dual-drive hybrid systems, physically separate SSD and HDD devices are installed in the same computer, having the data placement optimization performed either manually by the end user or automatically by the operating system through the creation of a “hybrid” logical device. In solid-state hybrid drives, SSD and HDD functionalities are built into a single piece of hardware, where data placement optimization is performed either entirely by the device (self-optimized mode), or through placement “hints” supplied by the operating system (host-hinted mode).

The term “magnet” as used herein refers to a material or object that produces a magnetic field. A permanent magnet is an object made from a material that is magnetized and creates a persistent magnetic field. A magnetizable material can be magnetized and is typically strongly attracted to a magnet. Such materials include ferromagnetic or ferrimagnetic materials, such as those comprising iron, nickel, cobalt, manganese, magnesium rare earths, and alloys thereof.

The term “means” as used herein shall be given its broadest possible interpretation in accordance with 35 U.S.C., Section(s) 112(f) and/or 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The term “module” as used herein refers to any known or later developed hardware, software, firmware, artificial intelligence, fuzzy logic, or combination of hardware and software that is capable of performing the functionality associated with that element.

The term “rare earth element”, also called the rare-earth metals, comprise the lanthanides, yttrium, and scandium. The lanthanides comprise lanthanum, cerium, praseodymium, neodymium, promethium, and samarium (known as the light rare earth elements or LREEs) and europium, gadolinium, terbium, dysprosium, holmium, erbium, thulium, ytterbium, and lutetium (known as the heavy rare earth elements or HREEs).

The term “rare earth magnet” is a permanent magnet comprising one or more rare earth elements, typically in the form of alloys. The two primary types of rare earth magnets comprise neodymium magnets and samarium-cobalt magnets. A neodymium magnet (also known as NdFeB, NIB or Neo magnet) is a permanent magnet made from an alloy of neodymium, iron, and boron to form the Nd₂Fe₁₄B tetragonal crystalline structure. A samarium-cobalt (SmCo) magnet is a permanent magnet made of two basic elements, namely samarium and cobalt.

A “solid state drive” (SSD) is a semiconductor-based storage device, which typically uses NAND flash memory to save persistent data. Unlike HDDs, SSDs typically do not comprise rare earth magnets.

“Transverse” means acting, lying, or being across: set crosswise. While transverse may refer to a selected axis being made at right angles to a long axis of a body, transverse as used herein can include any other angle or orientation so long as selected axes are not parallel to one another.

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein. By way of example, the phrase from about 2 to about 4 includes the whole number and/or integer ranges from about 2 to about 3, from about 3 to about 4 and each possible range based on real (e.g., irrational and/or rational) numbers, such as from about 2.1 to about 4.9, from about 2.1 to about 3.4, and so on.

The preceding is a simplified summary of the disclosure to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present disclosure. These drawings, together with the description, explain the principles of disclosure. The drawings simply illustrate preferred and alternative examples of how the disclosure can be made and used and are not to be construed as limiting the disclosure to only the illustrated and described examples. Further features and advantages will become apparent from the following, more detailed, description of the various embodiments of the disclosure, as illustrated by the drawings referenced below.

FIG. 1 is a perspective view of an HD recycling system in accordance with aspects of the present disclosure;

FIG. 2 is a perspective view of the HD recycling system with a safety enclosure in accordance with aspects of the present disclosure;

FIG. 3 is a sectional plan view looking down at the lower press in accordance with aspects of the present disclosure;

FIG. 4 is a flow schematic of the operation of the HD recycling system in accordance with aspects of the present disclosure;

FIG. 5 depicts an operational configuration of the HD recycling system in accordance with aspects of the present disclosure;

FIG. 6 depicts an operational configuration of the HD recycling system in accordance with aspects of the present disclosure;

FIG. 7 depicts an operational configuration of the HD recycling system in accordance with aspects of the present disclosure;

FIG. 8 depicts an operational configuration of the HD recycling system in accordance with aspects of the present disclosure;

FIG. 9 depicts an operational configuration of the HD recycling system in accordance with aspects of the present disclosure;

FIG. 10 is a side view of an open die assembly according to the operational configuration of the HD recycling system;

FIG. 11 is a side view of a closed die assembly according to the operational configuration of the HD recycling system shown in FIG. 10;

FIG. 12 is a side view of the open die assembly according to the operational configuration of the HD recycling system of FIG. 10 and displaying an elevated position of the die assembly before shearing of the HDD;

FIG. 13 is a side view of the closed die assembly according to the operational configuration of the HD recycling system of FIG. 11 and displaying a shearing position of the die assembly during shearing of the HDD; and

FIG. 14 is a block diagram of a system control system according to an embodiment of the disclosure.

### DETAILED DESCRIPTION

In some aspects of the disclosure, a magnet-containing hard drive recycling system is provided that can efficiently separate rare earth magnets from a plurality of end-of-life magnet-containing hard drives, such as hard disk drives (HDDs) and hybrid drives. As will be appreciated, HDDs comprise hard disk platters only and no flash drives while hybrid drives comprise both solid state drives and hard disk drives. The magnet-containing hard drive recycling system can include one or more of the following features:
a magnet detection/orientation sensor that senses a magnetic field generated by a rare earth magnet in one or more peripheral corners and/or edges of the magnet-containing hard drive as opposed to sensing magnetic fields generated by rare earth magnets over the entire surface area of the magnet-containing hard drive;
an entry gate operated by a pneumatic cylinder which is controlled by the magnet detection sensor. when a magnet-containing hard drive is inserted into the feed slot and is in the proper orientation the entry gate enables and allows the magnet containing hard drive to pass to the loading position. Otherwise, the pneumatic cylinder operated entry gate remains closed preventing the passage of any hard drives with out correct orientation. The entry gate can be operated by a pneumatic, hydraulic, electro-mechanical cylinder or other similar means; and
a positioning proximity sensor to verify the hard disk is in the ready loading position after its orientation has been verified and been allowed to pass through the entry gate.
a mechanical or hydraulic press using a punch press as a shearing tool to cut a corner of the magnet-containing hard drive comprising the actuator including the voice coil magnets from the remainder of the magnet-containing hard drive body comprising other components such as an electronics card, platter containing sensitive stored information, spindle, read/write head, and head arm;
a conveyor/receptacle system that uses separate conveyors and storage bins for HD cut corners on the one hand and HD cut bodies on the other; and
a discharge system that separates the cut corner (which comprises no storage medium containing sensitive information) for recycle of the contained rare earth magnets from the magnet-containing hard drive body for disposition in accordance with applicable information privacy laws and regulations, such as IT Asset Disposition (ITAD), Gramm-Leach-Bliley Act (“GLBA”) 501, and the Health Insurance Portability and Accountability Act (“HIPAA”).

In some aspects of the disclosure, the magnet-containing hard drive recycling system includes a feed slot, pusher assembly, magnet detection sensor, mechanical press, shearing tool, ejection rollers, press lubricator, chute, conveyors and storage bins. The magnet-containing hard drive recycling system breaks the magnet-containing hard drive into two parts, namely a corner bearing the rare earth magnet(s) in the actuator and a remaining hard drive body, typically with the action of a mechanical press and shearing tool. The two parts can be ejected with the action of ejection rollers to different chutes, with a first conveyor in communication with a first chute directing the magnet-containing hard drive body and a second conveyor in communication with a second chute directing the magnet-containing hard drive corner for collection in separate storage bins. The magnet-containing hard drive recycling system can also include a machine guard, access gate with a safety latch, an operation control station, an air compressor, a power distribution panel, and fork truck lifting pockets for portability.

Before discussing the magnet-containing hard drive recycling system, the HD itself will be discussed. A typical HD comprises the primary components of a top cover, a mounting chassis, electronics card, platter, spindle, read/write head, head arm, and actuator. The actuator (e.g., voice coil) magnet(s), spindle motor magnet, and read/write heads can each comprise one or more rare earth magnets. The various components are typically universally positioned across HDs of different manufacturers and form factors. A cut of approximately 45 degrees through the HD can separate the actuator rare earth magnet(s) from the remaining components of the HD, including the platter, spindle motor, and read/write head, and head or actuator arm. Thus, the rare earth-containing magnets in the actuator are separated in the cut corner from the other components and the much smaller rare earth magnet(s) in the other components. Hybrid drives typically have a similar layout.

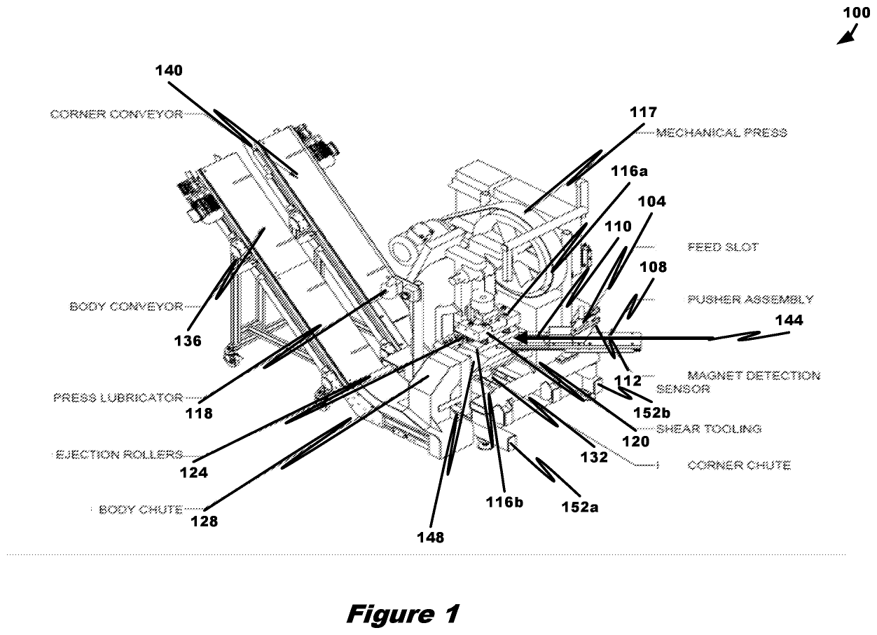

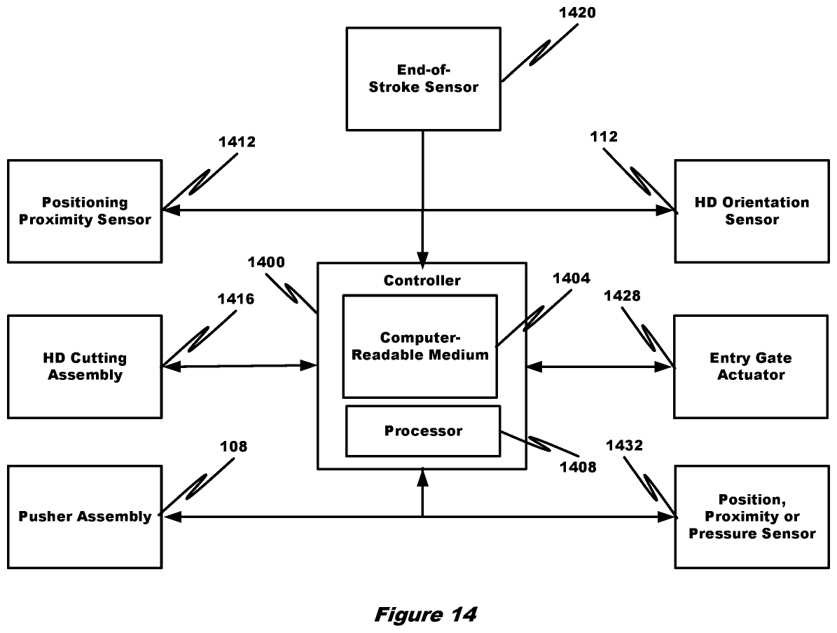

Referring to FIGS. 1, 2, and 14, a magnet-containing hard drive recycling system in accordance with embodiments of the disclosure will be described. The magnet-containing hard drive recycling system 100 comprises an inclined magnet-containing hard drive feed slot 104, magnet-containing hard drive pusher assembly 108, magnet-containing hard drive orientation sensor 112 positioned in the slot 104 or a feed rail 110, and a cutting assembly 1416 comprising upper and lower press plates 116a,b (one or both of which moves towards or away from each other depending on the operational mode of the cutting system) and shear tooling 120 in communication with a mechanical press 117 and press lubricator 118, magnet-containing hard drive ejection rollers 124, magnet-containing hard drive body chute 128, magnet-containing hard drive corner chute 132, magnet-containing hard drive body conveyor 136, and magnet-containing hard drive corner conveyor 140.

The magnet-containing hard drive recycling system further comprises a controller 1400 in signal communication with the HD orientation sensor 112, a positioning proximity sensor 1412, the cutting assembly 1416, an entry gate actuator 1428, the pusher assembly 108, and a position, proximity or pressure sensor 1432. The controller comprises a computer-readable medium 1404 comprising executable instructions to receive and process input from the various sensors 112, 1412, and 1432 and perform the various described operations in response to the sensor input and a processor 1408.

The magnet-containing hard drive feed slot 104 is a slot sized to receive a variety of form factor magnet-containing hard drives in serial fashion.

The magnet-containing hard drive pusher assembly 108 comprises a pneumatically, hydraulically, or mechanically displaceable arm and plate operated by the controller 1400 that pushes the magnet-containing hard drive after input into the magnet-containing hard drive feed slot 104 and feed rail or guide track 110 in the feed direction 144. As can be seen from FIG. 1, the feed slot 104 is inclined relative to the feed rail or guide track 110. The pusher assembly 108 in response to input from the controller 1400 moves the HD horizontally along the feed rail or guide track 110, and, when the pusher reaches an end-of-stroke sensor 1420, the controller 1400, in response to receiving electrical signal input from the end-of-stroke sensor, causes the pusher assembly 108 to return to a start push position,

The magnet-containing hard drive orientation sensor 112, in electrical communication with the magnet-containing hard drive pusher assembly 108 and a controller 1400, in response to electrical signal input from the hard drive orientation sensor 112, determines whether the inserted magnet-containing hard drive is in a proper orientation, namely with the actuator and voice coil magnets positioned on the right side relative to the feed direction 144. When the inserted magnet-containing hard drive is in an improper orientation, the controller 1400, based on the sensor electrical signal input, provides a first binary orientation signal to the pusher assembly 108 not to activate to push the magnet-containing hard drive towards an adjacent, previously fed magnet-containing hard drive positioned in the rail or guide track. An alarm triggered by the controller 1400 can alert the user to remove and reorient the magnet-containing hard drive. Alternatively, the magnet-containing hard drive, in response to commands from the controller 1400, can be rejected from the feed slot for reinsertion by the user or a reorientation mechanism can automatically reorient or orient the magnet-containing hard drive depending on in which corner the magnet is detected. When the inserted magnet-containing hard drive is in a proper orientation, the controller 1400, based on the sensor electrical signal input, provides a second binary orientation signal to the pusher assembly to activate and push the magnet-containing hard drive towards the adjacent magnet-containing hard drive positioned in the rail or guide track.

Sensor 112 can be any suitable sensing device able to determine that the inserted magnet-containing hard drive is in the proper or improper orientation. In one configuration, the sensor is a magnetic sensor that determines the position of the magnets inside the magnet-containing hard drive relative to the magnet-containing hard drive feed slot 104. Exemplary magnetic sensors comprise a Hall effect sensor comprising one or more Hall probes (e.g., a planar Hall sensor), magnetic anomaly detector, magnetometer, MEMS magnetic field sensor, and the like.

In one application, the magnetic sensor can be one or more magnetometers positioned to sense a magnetic field strength over the upper or lower surface of the magnet-containing hard drive cassette. For example, to address differing field strengths across the magnet-containing hard drive, multiple types of magnetometers having differing sensitivities/ranges tailored to sense different magnetic field strengths can be used. The various sensed field strengths can be combined to generate a single magnetic image. Regardless of whether one or multiple magnetometers are employed, a processor maps, for a given magnet-containing hard drive, against one or more magnetic image templates to determine whether the sensed magnetic field strength distribution is associated with a proper orientation of the magnet-containing hard drive in the magnet-containing hard drive feed slot. As will be appreciated, a library of magnetic image templates can be used, with each magnetic image template corresponding to a respective type or form factor magnet-containing hard drive.

In one application, the magnetic sensor uses one or more magnetometers to sense the magnetic field strength in only a portion of the magnet-containing hard drive as opposed to over the entire body of the magnet-containing hard drive. The portion of the magnet-containing hard drive that is scanned is typically one or more peripheral corners and/or peripheral edges of the magnet-containing hard drive where the voice coil magnets would be located if the magnet-containing hard drive were oriented properly. In one configuration, multiple corners are scanned for the presence of absence of a magnet. In other words, the magnetic field in the remainder of the magnet-containing hard drive, such as originating from the rare earth magnets in the spindle and/or read/write head, is not sensed in generating the orientation signal. Due to sensing of a weak magnetic field from rare earth magnets positioned in the body of the drive, the orientation signal is typically generated in response to the sensor sensing a magnetic field strength of at least a predetermined strength in the corner or peripheral edges of the magnet-containing hard drive. In contrast to the prior application, the processing time required to generate the orientation signal is less resource intensive and much faster, thereby supporting along with a punch press to cut the HD cassette a higher magnet-containing hard drive throughput.

As will be appreciated, other types of sensors can be employed depending on the application. For example, an imaging sensor can also be used as an orientation sensor. A diffracted or reflected light pattern from the upper or lower top cover or mounting chassis of the magnet-containing hard drive can be used to identify an occurrence or non-occurrence of a specific feature, such as a bar code, QR code, serial number, and the like that would normally be present in a proper or improper orientation. An image sensor or imager is a sensor that detects and conveys information used to form an image. It does so by converting the variable attenuation of light waves (as they pass through or reflect off objects) into electrical signals that convey the information. The image sensor can be a charge-coupled device (CCD) or active-pixel sensor (CMOS).

To trigger intermittent or discontinuous operation of sensor 112, a magnet-containing hard drive insertion sensor (not shown) can be positioned in spatial proximity to the magnet-containing hard drive feed slot. 104. Exemplary insertion sensors include electro-optical sensors that convert light, or a change in light, into an electronic signal. For instance, the magnet-containing hard drive insertion sensor can be a position sensor that activates when the inserted magnet-containing hard drive interrupts a light beam. Photoelectric sensors can detect the distance to or absence or presence of the magnet-containing hard drive in the magnet-containing hard drive feed slot. Other photo-electric sensor include a photoconductive device that converts a change in incident light into a change in resistance in a control feedback circuit in which a change in resistance triggers the sensor 112, a photodiode or phototransistor that converts an amount of incident light into an output current with a change in the amount of incident light due to passage of the magnet-containing hard drive in the feed slot being the trigger for activating or deactivating the sensor 112, and the like.

Other types of sensors can be used to activate or deactivate sensor 112. For example, a motion sensor can detect passage or movement of the magnet-containing hard drive in the feed slot, a position or proximity sensor can detect a position of the magnet-containing hard drive in the feed slot, a Reed switch can be triggered by an applied magnetic field such as emitted by the magnet-containing hard drive, and an electromechanical sensor can comprise a movable member that is detected or moved in response to contact with the inserted magnet-containing hard drive, among others.

In some applications, the magnetic sensor is used without a magnet-containing hard drive insertion sensor. In such applications, a reed switch can be employed. As will be appreciated, the switching mechanism of a reed switch is typically comprised of two ferromagnetic blades, separated by only a few microns. When a magnet approaches the blades, the two blades pull toward one another. Once touching, the blades close the normally open (NO) contacts, thereby allowing electricity to flow. Some reed switches also contain a non-ferromagnetic contact, which forms a normally closed (NC) output. An approaching magnet will disconnect the contact and pull away from the switching contact. The contacts are commonly constructed from a variety of metals, including tungsten and rhodium. In some configurations, a housing filled with an inert gas (e.g., nitrogen) seals the contacts at an internal pressure under one atmosphere. Sealing isolates the contacts, thereby preventing corrosion and any sparks that might result from contact movement.

When in the proper orientation, the magnet-containing hard drive pusher assembly 108 pushes the inserted magnet-containing hard drive along the rail or guide track 110 against previously pushed magnet-containing hard drives in the rail or guide track 110 in the feed direction 144, thereby forcing a next magnet-containing hard drive into the space between the retracted upper and lower press plates 116a,b in communication with the hydraulically, pneumatically, or electromechanically operated mechanical press 117. As will be appreciated, press lubricator 118 periodically (typically after one or more cutting cycles) supplies lubricant to the mechanical press and punch tooling to ensure smooth operation.

Upon the completion of the pushing operation and/or in response to feedback of a magnet-containing hard drive positioning proximity sensor 1412 (such as the types of sensors used by the magnet-containing hard drive insertion sensor) indicating that a magnet-containing hard drive is properly positioned between the upper and lower press plates 116a,b, the controller 1400 causes the mechanical press 117 to displace the retracted upper and/or lower press plates 116a,b and shear tooling 120 towards each other until the next magnet-containing hard drive (now positioned between the press plates in response to displacement of the inserted magnet-containing hard drive by the pusher assembly) is firmly compressed between the fully extended press plates.

In one configuration, the lower press plate is fixed or stationary while the upper press plate, which comprises a blade or punch to cut the corner moves up and down. In a typical configuration, a vertical sliding ram engages the press plates. The bottom portion of the press is locked to the bottom bed plate and the top portion of the press is locked to the sliding ram. Top and bottom portions of the tool are generally guided by suitable pillar and bush assemblies, which gives safety to the punching elements of the tool. The punch press can include a die set comprising a set of punches (male) and dies (female) which, when pressed together, form a cut in the magnet-containing hard drive. The punches and dies are removable, with the punch being attached to the ram during the punching process. The ram moves up and down in a vertical linear motion, forcing the punch through the material into the die.

A position, displacement, or pressure sensor 1432 (such as a piezocapacitive pressure sensor or piezoelectric sensor) positioned on one or more of the press plates can indicate that the upper and lower press plates are in the fully retracted or extended position. For example, a pressure sensor can indicate that the press plates exert at least a predetermined pressure on the magnet-containing hard drive, at which the shear tooling 120 cleanly cuts the corner of the magnet-containing hard drive comprising the voice coil from the remainder of the magnet-containing hard drive.

While the shear tooling is discussed herein, it will be appreciated that any metal cutting device, die cutting blade, oscillating, circular, reciprocal, or otherwise moving cutting blade, laser cutter, or plasma cutter capable of cutting or shearing the magnet-containing hard drive may be employed, including an alligator shear cutter, punch press operated by the mechanical press 117, and the like.

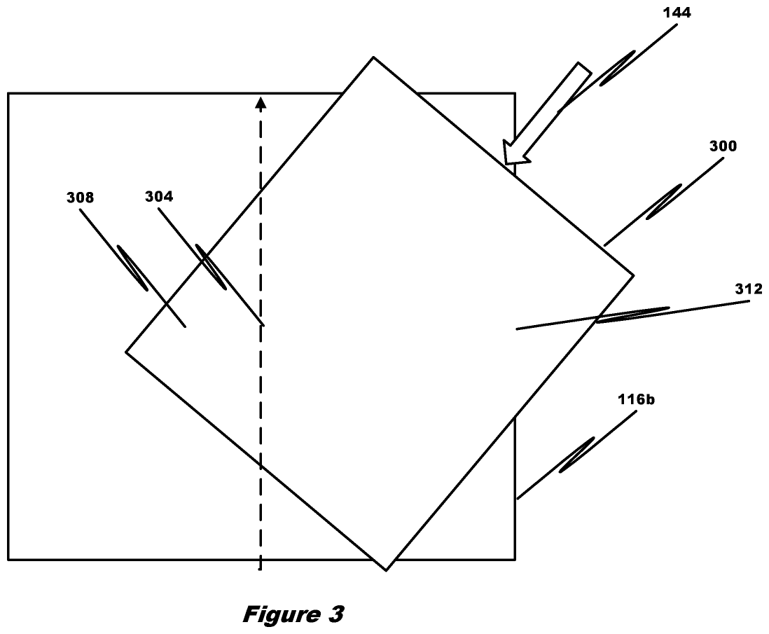

As shown in FIG. 3, the shear tooling 120 cuts the corner of magnet-containing hard drive 300 along cut line 304, which is typically oriented at a 45 degree angle relative to the feed direction 144 to separate the corner 308 comprising the actuator or voice coil magnets from the remaining body 312 of the magnet-containing hard drive 300.

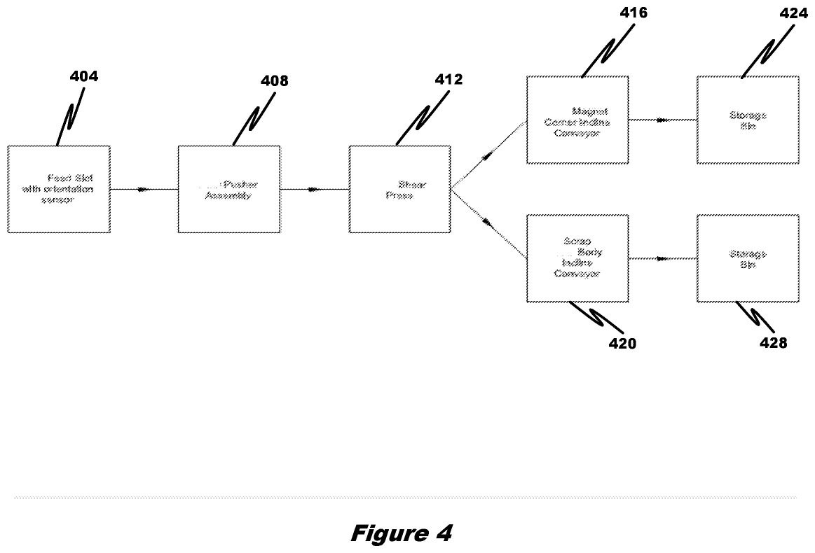

With reference to FIG. 4 and continued reference to FIGS. 1-3, when a next magnet-containing hard drive is inserted in a proper orientation in the feed slot 108 (operation 404), the magnet-containing hard drive pusher assembly 144 displaces the enqueued magnet-containing hard drives 300 in the rail or guide track towards the upper and lower press plates (operation 408) to cause the next magnet-containing hard drive to move into position between the press plates for a next cut (operation 412) and the cut corners fall straight down into the magnet-containing hard drive corner chute and the body 312 moves along ramp 148 and falls into the hard drive body chute 128. The cut corner 308 is fed by the magnet-containing hard drive corner chute 132 onto the inclined magnet-containing hard drive corner conveyor 140 which transports the cut corner into a cut corner storage bin 424 (operation 416) and the body 312 is fed by the hard drive body chute 128 onto the inclined hard drive body conveyor 136 which transports the hard drive body into a separate hard drive body storage bin 428 (operation 420).

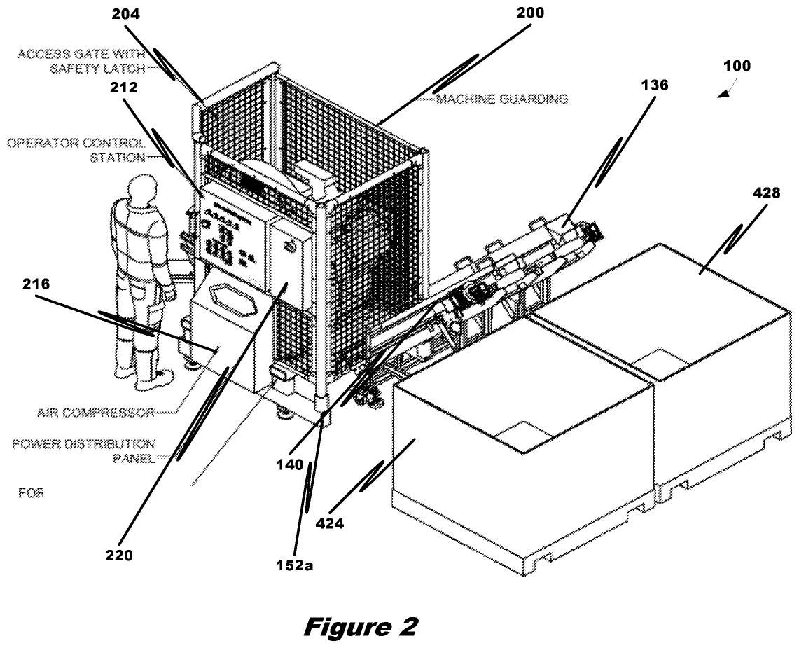

With reference to FIG. 2, the magnet-containing hard drive recycling system 100 can comprise surrounding machine guarding 200 including an access gate with safety latch 204, an operator control station 208 comprising an operator control station 212 to control manually operation of the system (e.g., on/off controls, etc.), an air compressor 216 for pneumatic operation of the pusher assembly 108 and mechanical press 117, and power distribution panel 220 to control power to the system 100, and first and second fork truck lifting pockets 152a,b for portability.

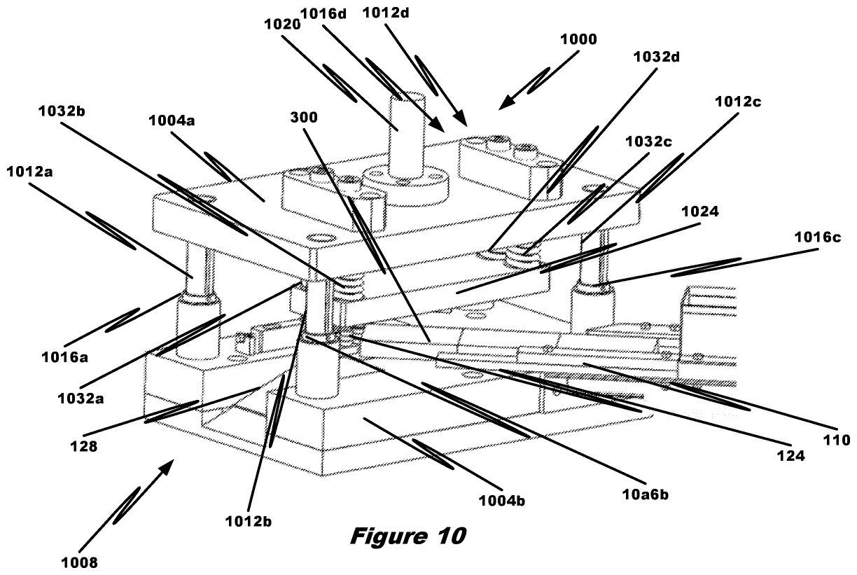

In another configuration, a cutting assembly configured as a cutting die style design can be used. With reference to FIGS. 10-13, the cutting assembly 1000 comprises upper and lower press plates 1004a,b, shear tooling 1008, upper press plate linear bearing shafts 1012a-d engaging linear bearings 1016a-d that cause the upper press plate 1004a to move upwards and downwards relative to the lower press plate 1004b in response to pressure imparted to the upper press plate 1004 by the mechanical press (not shown), and stripper plate 1024 connected with the upper press plate 1004a by plural spring guides 1028a-d telescopically positioned within springs 1032a-d. The upper press plate 1004a is laterally maintained in position by the linear bearings 1016a-d and acts as an upper die shoe to which the shear tooling 1008 is attached. The linear bearings 1016a-d rigidly guide the shearing tool 1008 while the spring-loaded stripper plate 1024 holds the HD 300 stationary during the corner cut of the HD 300. This cutting assembly design can make changeover of tooling faster and more repeatable. Wear on the guide rails 1012a-d and linear bearings 1016a-d of the press can also be reduced ensuring a longer life for the cutting assembly.

In the cutting die style design the ejection rollers 124 (and optionally cut rollers) are mounted on the lower press plate 1004b on compliant springs (not shown). As the shearing tool 1008 moves down to cut the corner of the HD 300, the shearing tool 1008 pushes the ejection rollers downwardly against the resistive force of the increasingly compressed springs and puts the ejection rollers into a first or disengaged position and thereby guide and eject the cut HD body. As the upper press plate moves upwardly, the springs 1032a-d continue to cause the stripper plate 1024 to contact the HD body even after the shearing tool 1008 is retracted. The stripper plate 1024 moves out of contact when the springs 1032a-d are no longer compressed in response to continued upward movement of the upper press plate 1004a. Unlike the directly mounted design of FIGS. 1 and 5-9, this cutting assembly design decouples the movement of the ejection rollers 124 from the press/shearing tool 1008, thereby allowing a faster and more reliable part ejection.

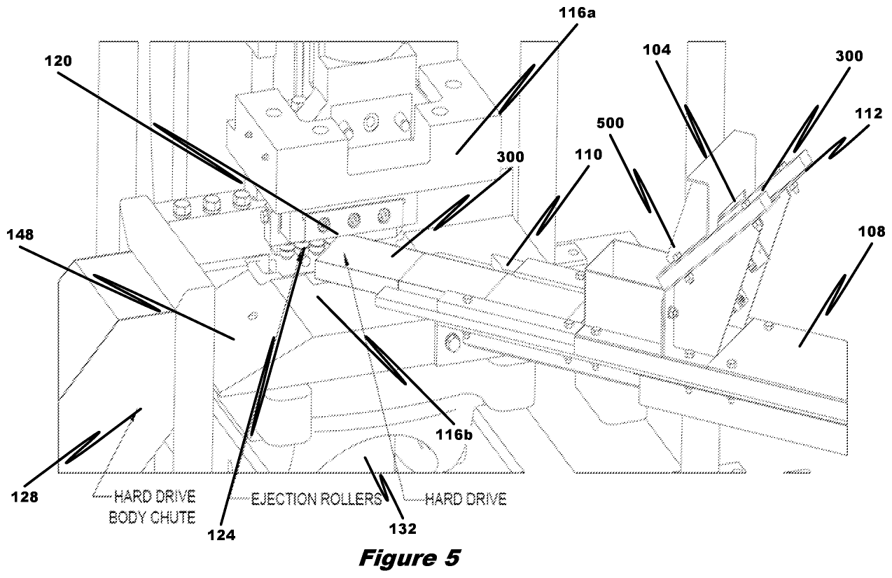

Differences between the directly mounted vs cutting die style tooling includes those shown in the table below:

| Direct Mount (FIGS. 5-9) | Cutting Die Style (FIGS. 10-13) |
|---|---|
| Shearing tool change can require every | Shearing tool changeover can be faster and |
| part to be removed separately | more repeatable |
| Upper and lower press plates are typically | Die assembly is typically a single unit |
| put together into the punch press | |
| The vertical motion can be guided by the | Vertical motion can be guided by plural |
| punch press itself | linear bearings, which can prolong the life |
| | of the punch press |
| Ejection rollers are typically attached to | Ejection rollers are typically mounted on |
| the cutter | the lower die shoe or press plate |

With reference to FIGS. 5-9, operations of a particular configuration of the magnet-containing hard drive recycling system 100 are depicted.

With reference 5, an inserted hard drive 300 is sensed by the sensor 112 as being in a proper orientation in the magnet-containing hard drive feed slot. 104. In response, the controller 1400 causes the pneumatically actuated entry gate 500 to open, enabling the inserted hard drive 300 to move, under the force of gravity, from the inclined slot 104 onto the substantially horizontally oriented rail or guide track 110, where it contacts a previously inserted hard drive 300 in a queue of hard drives in the rail or guide track. After a predetermined pause after opening and/or closing of the entry gate 500, the magnet-containing hard drive pusher assembly 108 pushes the inserted magnet-containing hard drive along the rail or guide track 110 against the enqueued and previously pushed magnet-containing hard drives in the rail or guide track 110 in the feed direction 144, thereby forcing a next magnet-containing hard drive into the space between the retracted upper and lower press plates 116a,b or 1004a,b in communication with the mechanical press 117 or hydraulic cylinder 1020, respectively. In this position, the leading hard drive 300 is in a cutting or shear cycle position, with the corner to be cut in contact with a first cut corner ejection roller.

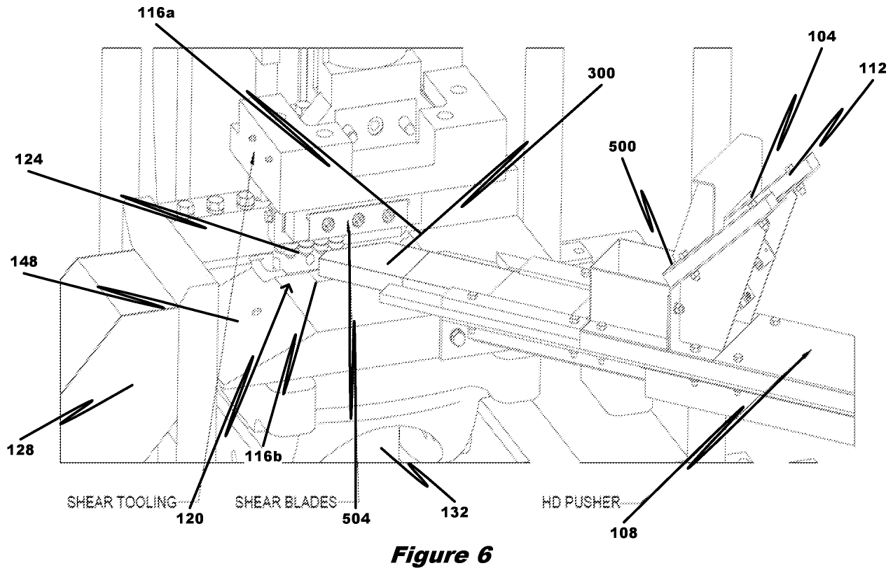

The cutting or shear cycle operations of the mechanical press embodiment will be discussed in connection with FIGS. 1 and 6 while those of the alternative mechanical press embodiment will be discussed in connection with FIGS. 10-13. As will be appreciated, hydraulic presses may be employed to perform some or all of the operations described herein.

With reference FIGS. 1 and 6, the upper press plate 116a comprising the shear tooling 120 and cutting blade 504 (or shear cycles) moves in response to input from the controller 1400 from a first fully retracted position to a second fully extended or cutting position to cut completely the HD corner 308 from the HD body 312. While not shown, a spring-loaded hold down clamp maintains the HD in position during HD recycling. The cut corner 308 falls into the cut corner chute 132 and is deposited on the cut corner conveyor 140.

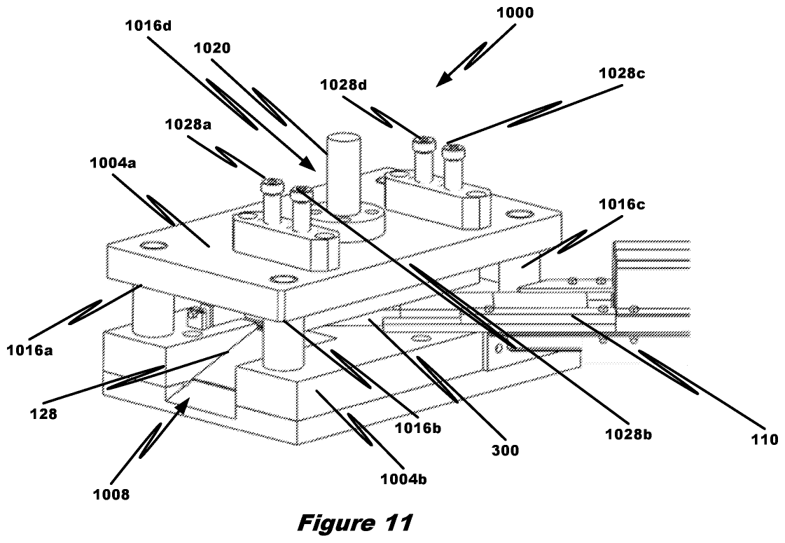

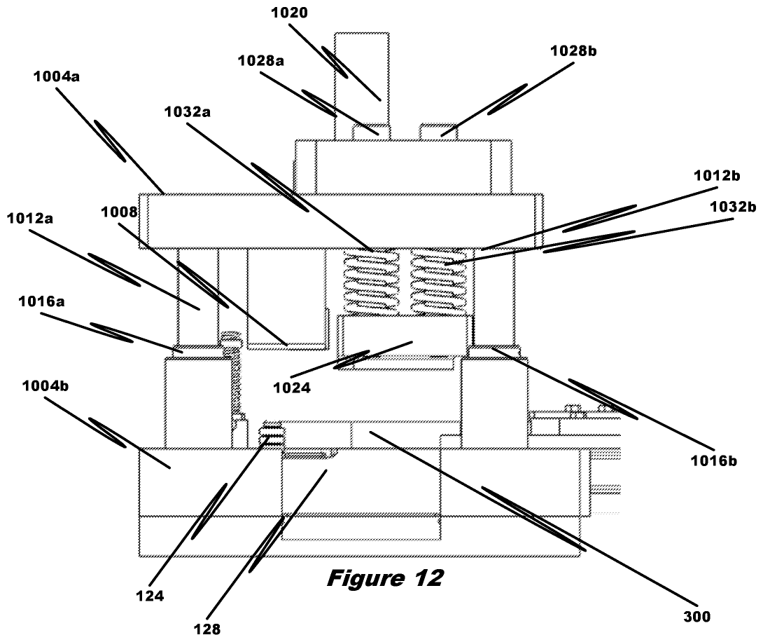

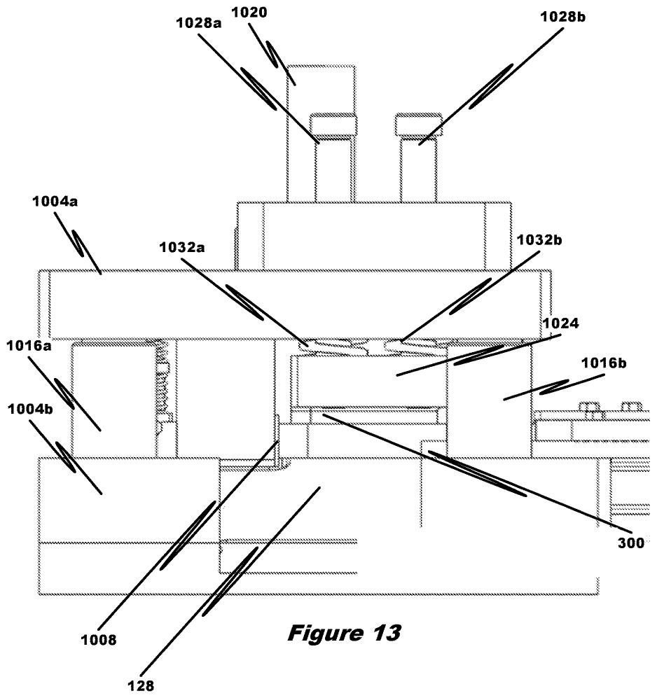

With reference FIGS. 10-13, the upper press plate 1004a comprising the shear tooling 1008 and cutting blade (or shear cycles) moves in response to input from the controller 1400 from a first fully retracted position shown in FIGS. 10 and 12 laterally along guides 1012a-d to a second fully extended or cutting position shown in FIGS. 11 and 13 to cut completely the HD corner 308 from the HD body 312. The compressed springs 1032a-d exert a counter force on the stripper plate 1024, thereby causing the stripper plate 1024 to hold the HD 300 rigidly in a cutting position to avoid the HD 300 moving during shearing. As in the case of the prior embodiment, the cut corner 308 falls into the cut corner chute 132 and is deposited on the cut corner conveyor 140.

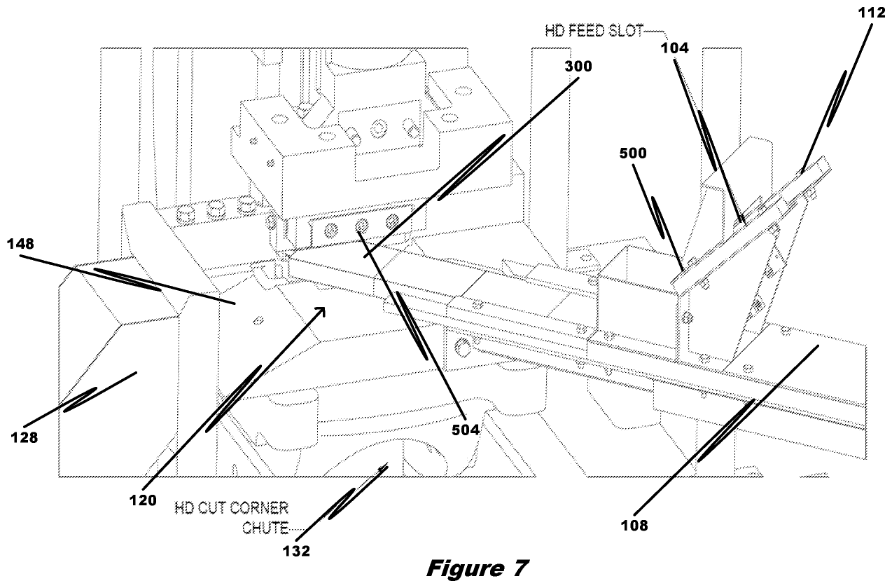

With reference to FIG. 7, the HD pusher assembly 108 in both embodiments, pushes a next hard drive 300 against the previously cut HD body 312 until the cut HD body 308 is in contact with one or more cut body ejection rollers (which are different from the cut corner ejection rollers used to transport the cut corner 304).

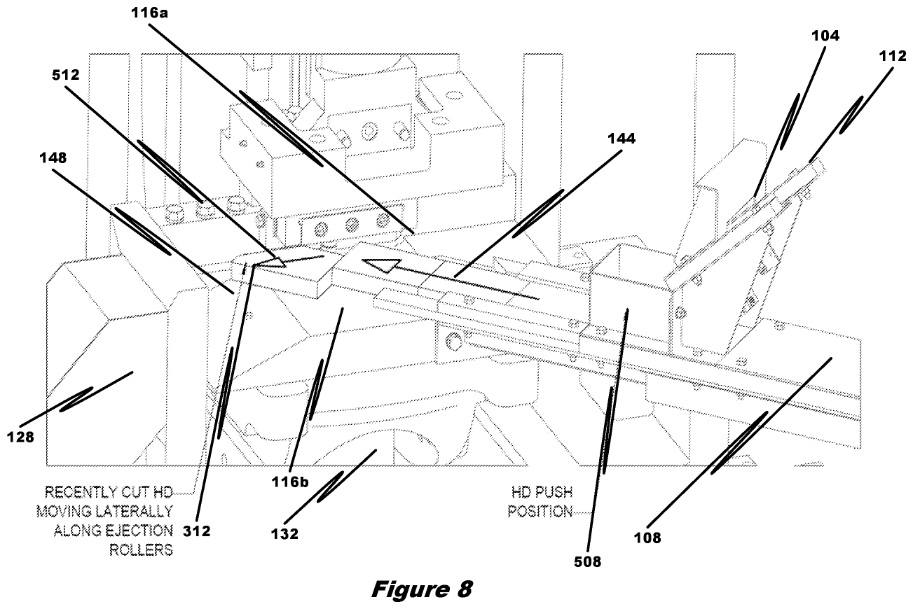

With reference to FIG. 8, in response to insertion of a next hard drive 300 in a proper orientation as discussed above, the pusher assembly 108 keeps moving forward, causing the previously cut HD body 312 to move laterally along the ejection rollers, thereby causing the HD body 312 to move along a path of travel transverse (e.g., typically 45 degrees) to the pusher assembly HD displacement axis and longitudinal axis of the rail or guide track 110. Because the different paths or travel or HD displacement for the cut and ejection rollers are transverse to each other and the pusher assembly HD displacement axis and longitudinal axis of the guide track 110, the HD body is ejected.

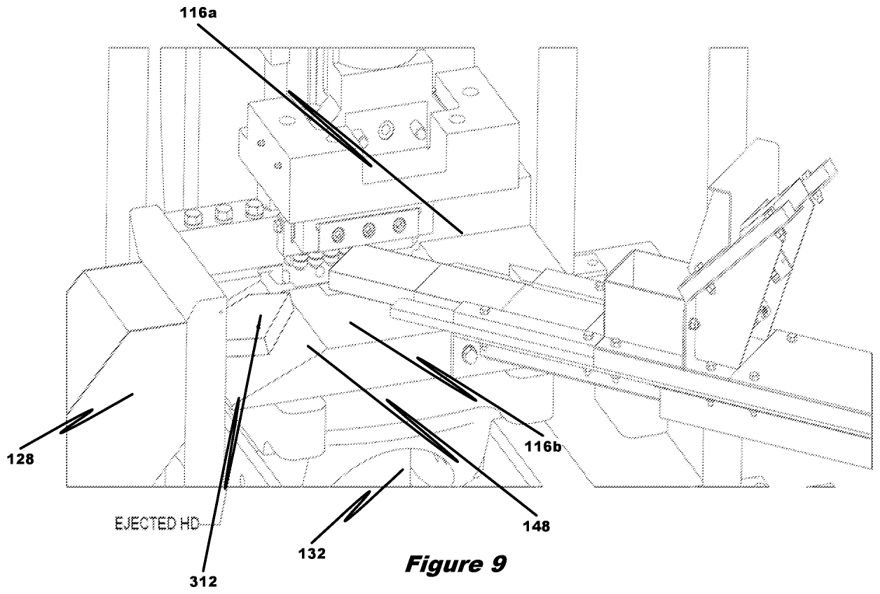

With reference to FIG. 9, the HD body 312 moves across the shear tooling, along ramp 148, and falls into the magnet-containing hard drive body chute 128 and onto the cut body conveyor 136. The next HD 300 is now in the cutting position between the press plates 116a,b as described above in FIG. 5 and is ready for the process to be repeated.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

The exemplary systems and methods of this disclosure have been described in relation to a rare magnet recycle system. However, to avoid unnecessarily obscuring the present disclosure, the preceding description omits a number of known structures and devices. This omission is not to be construed as a limitation of the scopes of the claims. Specific details are set forth to provide an understanding of the present disclosure. It should however be appreciated that the present disclosure may be practiced in a variety of ways beyond the specific detail set forth herein.

Also, while the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In other embodiments, a cutting or shearing device other than a press may be employed. The cutting or shearing device can, for example, be a shear cutter, rotary blade, and other single-point and multi-point cutting tools and abrasive cutting tools.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A magnet-containing hard drive recycling system comprising:
an input to receive a hard drive, the hard drive comprising a rare earth magnet in one or more peripheral corners and/or edges of the hard drive;
a guide track in communication with the input to transport the received hard drive into a cutting position;
a plane of the cutting surface is positioned transverse to a longitudinal axis of the guide track to cut the one or more peripheral corners and/or edges from the hard drive to form a rare earth magnet-containing portion and a hard drive body portion;
a first output to receive the rare earth-magnet-containing portion; and
a second output to receive the hard drive body portion, wherein the pusher assembly is configured to push a next hard drive into the cutting position causing the rare earth magnet-containing portion to be displaced into the first output and the hard drive body portion to be displaced into the second output.

2. The hard drive recycling system of claim 1, further comprising:
a pusher assembly positioned along the guide track to push the hard drive into the cutting position relative to the plane of the cutting surface, wherein the plane of the cutting surface is positioned transverse to the longitudinal axis of the guide track.

3. The hard drive recycling system of claim 2, further comprising:
a hard drive orientation sensor to sense whether or not the hard drive is in a correct orientation relative to the plane of the cutting surface to form the rare earth magnet-containing portion.

4. The hard drive recycling system of claim 2, further comprising:
a processor that causes the pusher assembly to push the hard drive into the cutting position when the hard drive orientation sensor senses that the hard drive is in the correct orientation and disables the pusher assembly from pushing the hard drive into the cutting position when the hard drive orientation sensor senses that the hard drive is not in the correct orientation.

5. The hard drive recycling system of claim 2, further comprising:
a set of cut rollers to receive the hard drive and, in response to displacement by the pusher assembly, enable the hard drive to move into the cutting position; and
a set of ejection rollers to receive the hard drive body portion and, in response to displacement by the pusher assembly, enable the hard drive body portion to be displaced into the second output, wherein the path of travel of the set of cut rollers is transverse to a path of travel of the set of ejection rollers.

6. The hard drive recycling system of claim 1, wherein the cutting surface comprises a cutting die attached to an upper press plate that causes the cutting surface to move laterally into and out of engagement with the hard drive and wherein movement of the upper press plate causes a stripper plate to move into and out of engagement with a surface of the hard drive to maintain the hard drive in position during cutting of the one or more peripheral corners and/or edges of the hard drive.

7. The hard drive recycling system of claim 5, wherein the set of cut rollers and/or the set of ejection rollers are moved into a first position with the hard drive during cutting of the one or more peripheral corners and/or edges of the hard drive and into a different second position after cutting of the one or more peripheral corners and/or edges of the hard drive and wherein a first resistance to movement of the hard drive in the first position of the set of cut rollers and/or the set of ejection rollers is greater than a second resistance to movement of the hard drive body in the second position of the set of cut rollers and/or the set of ejection rollers.

8. A method for cutting a magnet-containing hard drive comprising:
receiving a hard drive comprising a rare earth magnet in one or more peripheral corners and/or edges of the hard drive;
displacing, by a set of cut rollers, the received hard drive along a guide track into a cutting position in which a plane of the cutting surface is transverse to a longitudinal axis of the guide track;
in the cutting position, cutting the one or more peripheral corners and/or edges of the hard drive to form a rare earth magnet-containing portion and a hard drive body portion;
removing by a first output the rare earth-magnet-containing portion;
removing by a different second output the hard drive body portion, and
displacing, by a set of ejection rollers, the hard drive body portion into the second output, wherein a first path of travel of the set of cut rollers is transverse to a second path of travel of the set of ejection rollers.

9. The method of claim 8, further comprising:
pushing, by a pusher assembly positioned along the guide track, the hard drive along a linear path of travel into the cutting position.

10. The method of claim 9, further comprising:
sensing, by a hard drive orientation sensor, whether or not the hard drive is in a correct orientation relative to the plane of the cutting surface to form the rare earth magnet-containing portion.

11. The method of claim 10, wherein the pusher assembly pushes a next hard drive into the cutting position causing the rare earth magnet-containing portion to be displaced into the first output and the hard drive body portion to be displaced into the second output.

12. The method of claim 10, further comprising:
when the hard drive orientation sensor senses that the hard drive is in the correct orientation, enabling the pusher assembly to push the hard drive into the cutting position, and
when the hard drive orientation sensor senses that the hard drive is not in the correct orientation, disabling the pusher assembly from pushing the hard drive into the cutting position.

13. The method of claim 8, wherein the cutting surface comprises a cutting die in operative communication with an upper press plate that causes the cutting surface to move down and up into and out of engagement with the hard drive and wherein movement of the upper press plate causes a stripper plate to move into and out of engagement with a surface of the hard drive to maintain the hard drive in position during cutting of the one or more peripheral corners and/or edges of the hard drive.

14. The method of claim 10, further comprising moving the set of cut rollers and/or the set of ejection rollers into a first position with the hard drive during cutting of the one or more peripheral corners and/or edges of the hard drive and into a different second position after cutting of the one or more peripheral corners and/or edges of the hard drive, wherein a first resistance to movement of the hard drive in the first position of the set of cut rollers and/or the set of ejection rollers is greater than a second resistance to movement of the hard drive body in the second position of the set of cut rollers and/or the set of ejection rollers.

15. A system for cutting a magnet-containing hard drive comprising:
a guide track to receive a hard drive comprising a rare earth magnet in one or more peripheral corners and/or edges of the hard drive;
a cutting surface configured to cut the one or more peripheral corners and/or edges from the hard drive from the hard drive when the hard drive is in a cutting position to form a rare earth magnet-containing portion and a hard drive body portion;
a hard drive orientation sensor to sense whether or not the hard drive is in a correct orientation relative to the plane of the cutting surface to form the rare earth magnet-containing
portion;
a displacement device to displace the hard drive along the guide track into the cutting position;
a first output for the rare earth-magnet-containing portion;
a different second output for the hard drive body portion;
a processor coupled with the hard drive orientation sensor and displacement device; and
a computer-readable medium coupled with and readable by the processor and storing therein a set of instructions which, when executed by the processor, causes the processor to:
enable the displacement device to displace the hard drive into the cutting position when the hard drive orientation sensor senses that the hard drive is in a first orientation; and
disable the displacement device from displacing the hard drive into the cutting position when the hard drive orientation sensor senses that the hard drive is not in the first orientation, wherein the processor, when the hard drive is properly positioned relative to the cutting surface, enables the cutting surface to cut the hard drive to form the rare earth magnet-containing portion and hard drive body portion and, when the hard drive is improperly positioned relative to the cutting surface, disables the cutting surface from cutting the hard drive to form the rare earth magnet-containing portion and hard drive body portion.

16. The system of claim 15, wherein the displacement device is along the guide track and wherein, when the hard drive is in the cutting position, the cutting surface plane is positioned transverse to the longitudinal axis of the guide track and further comprising a positioning proximity sensor to sense whether or not the hard drive is properly positioned relative to the cutting surface.

17. The system of claim 15, wherein the displacement device is configured to push a next hard drive into the cutting position causing the rare earth magnet-containing portion to be displaced into the first output and the hard drive body portion to be displaced into the second output.

18. The system of claim 15, further comprising:
a set of cut rollers to receive the hard drive and, in response to displacement by the pusher assembly, enable the hard drive to move into the cutting position; and
a set of ejection rollers to receive the hard drive body portion and, in response to displacement by the pusher assembly, enable the hard drive body portion to be displaced into the second output, wherein a first path of travel of the set of cut rollers is transverse to a second path of travel of the set of ejection rollers.

19. The system of claim 15, wherein the cutting surface comprises a cutting die attached to an upper press plate that causes the cutting surface to move laterally into and out of engagement with the hard drive and wherein movement of the upper press plate causes a stripper plate to move into and out of engagement with a surface of the hard drive to maintain the hard drive in position during cutting of the one or more peripheral corners and/or edges of the hard drive.

20. The system of claim 18, wherein the set of cut rollers and/or the set of ejection rollers are moved into a first position with the hard drive during cutting of the one or more peripheral corners and/or edges of the hard drive and into a different second position after cutting of the one or more peripheral corners and/or edges of the hard drive and wherein a first resistance to movement of the hard drive in the first position of the set of cut rollers and/or the set of ejection rollers is greater than a second resistance to movement of the hard drive body in the second position of the set of cut rollers and/or the set of ejection rollers.
